(19) United States
(12) Patent Application Publication
(10) Pub. No.: US 2010/0043298 A1
(43) Pub. Date: Feb. 25, 2010

(54) Hinged Partition and Arrangement for Closing Off a Room Against a Fluid Flowing into the Room or Out of the Room

(76) Inventor: Dag Anhamm, Moers (DE)

Correspondence Address: SMITH LAW OFFICE, 8000 EXCELSIOR DRIVE, SUITE 301, MADISON, WI, 53717, US

(21) Appl. No.: 12/085,118

(22) PCT Filed: Nov. 17, 2006
(86) PCT No.: PCT/EP2006/011054

§ 371 Date: Oct. 13, 2009

(30) Foreign Application Priority Data
Nov. 18, 2005 (DE) 102005055017.7

(51) Int. Cl. E06B 7/16; E05C 19/00

(52) U.S. Cl. 49/383; 292/2

(57) ABSTRACT

An arrangement which has a hinged partition is proposed in order to close off a room against a fluid, in particular a flammable liquid, flowing into the room or out of the room. The hinged partition can be pivoted about an axis from a first position into a second position. A seal of sheet-like formation is connected to the hinged partition and a frame. At least one screening means is provided in the side regions of the seal and of the hinged partition, this screening means protecting the seal against increased levels of heat.

### FIELD AND BACKGROUND OF THE INVENTION

The object of the invention refers to an arrangement for closing off a room against a fluid flowing into the room or out from the room, especially a combustible fluid.

It is known that doors or passageways of a room, especially of a workshop or of a storage room can be closed off by partitions. A hinged partition is to ensure that a fluid cannot leave a room or enter into this room. The fluids can be water, chemicals, oils or their mixtures. Such fluids or fluid mixtures occur especially when water used for fire extinguishing by the fire department or by a sprinkling installation is pumped into the room. Moreover, especially in the case of hazardous material storage, there is a necessity to close off the storage against the exit of fluids into the surroundings.

A room is defined not only as a building or a part of a building, such as, for example an underground parking structure, a workshop, a storage room, etc., but also areas delimited by boundaries, for example walls, that have at least one opening, for example in the form of a passageway which must be closed as needed.

Various embodiments of arrangements for closing off a room against a fluid flowing into the room or out of the room are known. From U.S. Pat. No. 5,460,462, a device for closing off is known in which a partition can be extended in a vertical direction. When this partition is extended, it forms a barrier.

Another embodiment for closing off a room is known from EP 0 586 356 A1. This has a flexible barrier which is formed by a tarpaulin. This tarpaulin is located in the floor and is connected to a pivotable tie-bar with which the tarpaulin is raised.

EP 0 754 822 A2 describes a device for closing off a room. The device has a partition that can be pivoted around an essentially horizontal axis and which can be lifted up by a drive from a recess provided in the floor of the room, as a function of a fluid entering into the recess. This hinged partition is designed as a float. The drive comprises at least one weight which can be moved essentially vertically, and which is connected to a drive that can be pivoted with the axis around the hinged partition. The weight causes a torque around the axis, which is greater than the torque acting around the axis by the gravitational force of the hinged partition when the hinged partition has been deviated from its essentially horizontal position in the recess by the fluid entering into the recess.

The hinged partition will lie against a seal, which is arranged in a corresponding frame that partially surrounds the opening. It is known that such a seal has an essentially rectangular cross-section. This elastically designed seal is intended to ensure that a fluid cannot enter into the room or leave the room. The problem in such a device is that, due to the manufacturing tolerances, an expensive alignment of the axis or of the hinged partition is necessary in order to ensure that the sealing function will be reached to a sufficient extent. Due to the large evolution of heat that occurs during fires, the problem arises that the components of the device behave differently thermally and the sealing function cannot be assured or can be assured only to a reduced extent.

A device for closing off a room against a fluid flowing into the room, especially water, is known from GB 2 403 254 A. The device has a pivotable hinged partition, which can be pivoted from a first position into a second position around an axis. The hinged partition has a flexible seal that has flaps protruding through an edge of the hinged partition running transversely to the longitudinal axis, and these flaps can be folded. The seal and the flaps are connected to the hinged partition through a frame, which is attached to the wall of the building. This measure is intended to ensure that entry of a fluid on the side between the hinged partition and the frame does not occur.

### SUMMARY OF THE INVENTION

Based on this, the task of the present invention is to provide an arrangement for closing off a room against a fluid flowing into the room or out from the room, especially a combustible fluid, which essentially ensures that no fluid leaves the room or enters into the room even at high temperatures, especially in the case of a fire.

This task is solved according to the invention by an arrangement for closing off a room against a fluid flowing into the room or out of from the room, especially a combustible fluid.

The arrangement according to the invention for closing off a room against a fluid flowing into the room or out from the room, especially a combustible fluid, has a hinged partition which can be pivoted from a first position into a second position around an axis, as well as a frame. A seal that is at least partially flexible is provided, which has at least one flap protruding beyond an edge running transversely to the axis, and this flap is joined to the hinged partition and to the room. At least one screening means is provided near the at least one flap.

With this design of the arrangement according to the invention, an improved sealing is achieved. The flexible seal is connected on the one side to the hinged partition and on the other side to a frame that is present in the area of a passageway or an opening, so that the sealing function is always present, especially independently of the position of the hinged partition.

The design of the arrangement according to the invention also makes simple mounting possible, since the sealing function now is almost independent of the position of the axis or of the hinged partition. Moreover, the arrangement according to the invention has the advantage that replacement of the seal is simplified. Thus now, in contrast to the state of the art, a specially trained person is not necessary for replacing the flexible seal.

The hinted partition can be pivoted around an axis from a first position into a second position. The second position can be a variable position. There is the possibility that, depending on the level of a fluid, the hinged partition will float up from a first position into a second position, which is dependent on the fluid level. The advantage of such an arrangement is that the hinged partition automatically returns to the first position when the level of the fluid drops again.

The flexible seal is preferably a seal that is sheet-like in design. Especially it is proposed that the seal be made at least partly of a plastic, especially of polytetrafluoroethylene (PTFE).

The properties of the seal can be easily adapted to the requirements. Thus, for example it is possible to manufacture the seal from a material that is resistant, for example, to aggressive media, for example acids, oils, gasoline, etc. There is also the possibility of producing the seal from a material that has an appropriately high melting point. Especially it is proposed that the seal be made of a material that is stable even at high temperatures. Especially, it is proposed that the seal be made of a material that has an ignition temperature of at least 150° C., preferably 220° C.

According to an advantageous embodiment of the arrangement according to the invention, it is proposed that the seals neighboring the axis have strips that project beyond the hinged partition. Hereby the dimensions of the strip are such that it bridges the gap between the hinged partition and, for example, a frame, whereby the strip is attached to the frame. In order to ensure that the seal will not be damaged, for example, by vehicles or similar when the hinged partition can be driven over, it is proposed that a drive-over protection be arranged over the seal. This drive-over protection can be made in the form of a pivotable cover, so that when the hinged partition is pivoted from a first position into a second position, the drive-over protection is also pivoted. As a result of this, blocking of the movement of the hinged partition by the drive-over protection is avoided.

Preferably it is proposed that tightening means be provided through which the flap can be tightened. The tightening means brings the flap into a suitable position when the hinged partition performs the closing function. The tightening means may have different designs. A design is preferred in which the tightening means is in the shape of loops. Especially it is proposed that a tightening means be provided in or at the edge region of the flap.

Through this arrangement according to the invention, an improved sealing function is achieved. This is true especially when the components of the arrangement have different thermal behavior as a result of the evolution of heat, and so that the difference in the thermal expansion of the frame and of the hinged partition is compensated by the at least partially flexible seal.

Another advantage of the device according to the invention for closing off a room against a fluid that flows into the room or out from the room can be regarded in the fact that the mounting of the device is simplified, since, through the flexible seal, the tolerance regarding the positioning of the axis can be compensated by the seal.

Due to the fact that near the at least one flap at least one screening means is provided, it is ensured that, especially upon exposure to higher temperatures, which is the case when a fire occurs, the flexible seal is protected, so that a fluid cannot flow out of the room or into the room.

Hereby an embodiment is preferred in which the screening means has a wall arranged essentially parallel to the edge of the hinged partition with the formation of a gap. The wall is preferably at least partly made of a material that is thermally stable at high temperatures, especially above 150° C. Especially preferred here is a design in which the wall is made at least partly from a fire-resistant material.

In order to further increase the protection of the seal against thermal effects, it is proposed that the wall preferably have a multilayered structure.

In order to prevent, for example, the action of the flames between the wall and the edge of the hinged partition on the seal, according to another further advantageous embodiment it is proposed that the edge have at least one lip, preferably a flexible lip, that extends at least partially in the longitudinal direction of the edge and lies against the wall.

According to a still further advantageous embodiment, it is proposed that a barrier be formed between the wall and the edge, made of a material that foams when a predetermined limiting temperature is exceeded. The material can preferably be a plastic, with a propellant that converts to the gaseous state upon exceeding a predetermined temperature and thus leads to the foaming of the plastic. Alternatively or additionally, the material can be a thermoplastic material that is compressed at ambient temperature and expands upon the action of heat.

The wall and/or the edge can be coated at least partly with such a material.

According to a still further advantageous embodiment of the arrangement, it is proposed that the hinged partition have at least one component that is moveable in the direction of the wall. This component is preferably designed so that the component will lie against the wall when the hinged partition is pivoted from the first position into the second position. Hereby a triggering mechanism can be provided, which releases the component, which is preferably under spring tension, so that this component is moved in the direction of the wall. Through this measure an essentially flame-proof closure between the hinged partition and the wall is achieved.

According to a still further advantageous embodiment of the invention, it is proposed that at least one essentially curved cover be provided, which covers the wall and an edge region of the hinged partition at least partly. Through this curved cover it is ensured that for example combustible fluids cannot enter into the region of the side seals of the hinged partition.

According to a still further advantageous embodiment of the device, it is proposed that at least one essentially curved flame section can be provided which has at least one flame opening. As a result of this, flames rising under the hinged partition are guided away by hydraulic technology so that the thermal load on the seal is reduced.

The air flow or the direction of the flames can be influenced further by the fact that the flame segment is arranged below the cover. The flow of the flames can be influenced by the number and design of the flame openings. Additionally, flow guide bodies may be provided in the area of the flame opening.

In order to protect especially the side seal from direct effect of flames, according to a still further advantageous embodiment of the arrangement, it is proposed that, in the area of the flaps, segments that can be pushed into one another in a fan-like manner may be provided.

According to a still further advantageous embodiment of the invention it is proposed that a drive be provided with the aid of which the partition can be pivoted around the axis. Hereby an embodiment is especially preferred in which a locking device is provided with the aid of which the partition is kept in the first position. A triggering device is connected to the locking device by means of which the partition is released so that the partition can be swiveled into the second position. With the aid of this advantageous embodiment of the device, it is achieved that the hinged partition can be moved from a first position into a second position only when a fluid is present. With the aid of the locking device, manual manipulation of the arrangement is also prevented.

The hinged partition is preferably designed as a float. The design of the hinged partition as a float limits the selection of the materials to be used. Moreover, the hinged partition must satisfy numerous requirements, for example that heavy equipment can travel over it, that it be heat resistant, mechanically stable and exhibit stability towards aggressive materials. This can have an adverse effect on the cost. Corresponding conditions apply to the application of additional floats since then additional space is also required. If the hinged partition is designed so that it is no longer floatable, then the gravitational force of the hinged partition must be compensated for by the application of additional forces. Such a compensation can be achieved, for example, by using springs.

The application of springs to the hinged partition is advantageous especially when the weakening spring action is compensated by an increase of the hydrostatic pressure. By the rotary movement of the hinged partition, the path of the spring is altered, which leads to a weakening of the spring force. The hydrostatic pressure increases with increasing height of the liquid level. Through the rotary movement of the hinged partition from the horizontal position into the vertical position, the torque caused by the weight of the hinged partition itself is reduced. In the combination of these forces, the decreasing spring force is compensated by suitable selection of the springs.

Instead of springs, at least one counterweight may also be used. For this purpose, optionally corresponding deflection pulleys are necessary so that the hinged partition can be transferred from the horizontal into the vertical position by the gravitational force of the counterweights. Through the resulting total course of the momentum, it is achieved that the hinged partition lies in the liquid for the most part at different liquid levels and the components lying above it are protected ideally from the flames and also the hinged partition is cooled by the fluid.

Application of springs directly on the surface of the hinged partition is especially advantageous. Tension springs and pressure springs are especially suitable for this. No additional complex means are needed for applying the at least one spring. Moreover, an essentially smooth sideways closure of the hinged partition is created. In this way the application of heat insulation and flame retardants is much simplified, since no expansion for shafts or holding elements for introducing the force is necessary. The application of the at least one spring is very simple and cost-effective. The spring can be applied above the hinged partition, as a result of which it is protected against heat and flame.

An embodiment in which at least one spring is arranged so that a tangential course of the spring force line occurs only after rotation of the hinged partition around its axis is especially advantageous. This is achieved especially when the angle between the sections of pivot point-force application and pivot point-spring attachment is greater than 90 degrees.

It is especially advantageous when the cross-section of the hinged partition is essentially wedge-shaped. In this way, a defined position of the hinged partition in a fluid is also achieved. The thickness of the hinged partition preferably decreases in the direction of the rotary axis. Moreover, the wedge-shaped design of the hinged partition has the advantage that the total weight of the hinged partition will be reduced. The reduction of the thickness of the barrier in the direction of the rotary axis has the advantage that the center of gravity and the midpoint of the lifting force are removed further from the pivot point. In this way better self-adjustment of the floating height is achieved, since the partition, when this is immersed further into the liquid, experiences a greater increase in the lifting force than when the barrier is designed to have a constant thickness. Similarly, when the partition rises further out of the fluid, a larger decrease of the volume available for buoyancy is achieved. Moreover, the incorporation of the hinged partition or of the arrangement is simplified with the aid of a pouring method, especially a concrete pouring method. As a result of the essentially wedge-shaped design of the hinged partition, essentially no air can collect under the hinged partition, which leads to the fact that the hinged partition will not be flooded underneath correctly, as a result of which the trough will not be attached correctly. This can lead to a bowing upward of the trough in which the hinged partition is arranged at these locations, and therefore the hinged partition will be pivoted away from the actually intended position and thus will no longer lie flat on the bottom. For example, if a vehicle drives over the hinged partition then the areas that are bowed upward will undergo a greater load, which may lead to a stress of the hinged partition since additional shifting of the load does not occur.

If springs are used for moving the hinged partition, then it is especially advantageous for the springs to be chosen so that the hinged partition can be pivoted manually with a small manual force over the entire pivoting range. This simplifies the cleaning and manual checking of the functioning of the hinged partition. Moreover, the danger of injury to the operator is highly reduced in this way. It is of especially great advantage when the spring force is adjusted so that the hinged partition after manual operation will be stopped automatically in the vertical position. In this way the cleaning of the barrier is simplified even further.

Other advantages and details of the hinged partition according to the invention as well as the arrangement according to the invention will be explained with the aid of the practical examples shown in the drawing, without the object of the invention being limited to these practical examples.

### BRIEF DESCRIPTION OF THE DRAWINGS

FIG. 1 is a perspective view of the a hinged partition,

FIG. 2 is a cross-section of the hinged partition according to FIG. 1,

FIG. 3 shows schematically an arrangement for the closing off of a room,

FIG. 4 is a sectional view of the arrangement,

FIG. 5 is a schematic and a perspective view of a hinged partition with walls,

FIG. 6 is an embodiment of an arrangement in a front view and in cross section with a moveable insulation.

FIG. 7 shows a first practical example of an arrangement with segmented screening means,

FIG. 8 shows a second practical example of the arrangement with segmented screening means,

FIG. 9 shows a first practical example of the arrangement with a curved cover,

FIG. 10 shows a practical example of the arrangement with a curved flame segment,

FIG. 11 shows a practical example of the arrangement with a curved cover and a curved flame segment,

FIG. 12 shows schematically a hinged partition with a spring suspension,

FIG. 13 is an example of the variation of the momentum of the hinged partition as a function of the angle at the maximum possible liquid level,

FIG. 14 shows the arrangement of a spring in a side view,

FIG. 15 is a diagram of the course of the torque,

FIG. 16 shows schematically a hinge connection of the hinged partition in a top view, and

FIG. 17 shows the hinged partition according to FIG. 16 in a side view.

### DETAILED DESCRIPTION OF THE PREFERRED EMBODIMENTS

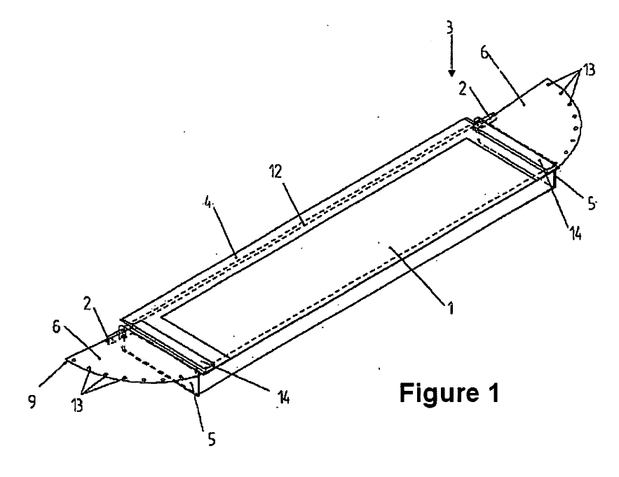

FIG. 1 shows a perspective view of a practical example of a hinged partition 1 of an arrangement for closing off a room against a fluid flowing into the room or out from the room, especially a combustible fluid. The hinged partition 1 is formed by a prismatic body in this representation, which can be sunk into a recess of a floor, the recess not being shown. The hinged partition 1 can be pivoted around an axis 2 from a first position into a second position. For example, the hinged partition 1 can have a metallic surface. It can be formed by a box made of metal in which a core is arranged that can be, for example, made of a plastic or similar material. A flame-retardant layer may be arranged between the core and the outer mantle.

In the practical example shown, the hinged partition 1 is connected to a seal 3. The seal 3 can be made of one or several parts. The seal 3 is designed in a sheet-like manner. Preferably it is made of polytetrafluoroethylene.

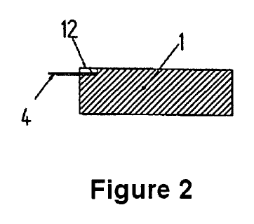

Next to the axis 2, the seal 3 has a strip 4. The strip 4 is connected to the hinged partition 1 through a cover strip 12. The joint is preferably constructed so that it is separable, for example, by having the cover strip 12 be screwed onto the hinged partition, so that the strip 4 of the seal 3 is clamped tightly onto the hinged partition 1, as can be seen from FIG. 2. The width of the strip 4 is dimensioned so that the strip 4 can be attached to the frame or floor, not shown, of the opening, which can be closed by the hinged partition.

Next to the edges 5 of the hinged partition 1, running transversely to the axis 2, flaps 6 are provided which form a part of the seal 3. The flaps 6 extend essentially over the entire length of edge 5. The blank of flaps 6 is chosen so that it is essentially in the shape of a quarter circle.

It can be seen from the representation in FIG. 2 that. in the edge region 9 of the flaps 6, openings 13 are provided, which form a part of the tightening means for tightening the flaps 6. The flaps 6 are attached to the hinged partition 1 with cover strips 14.

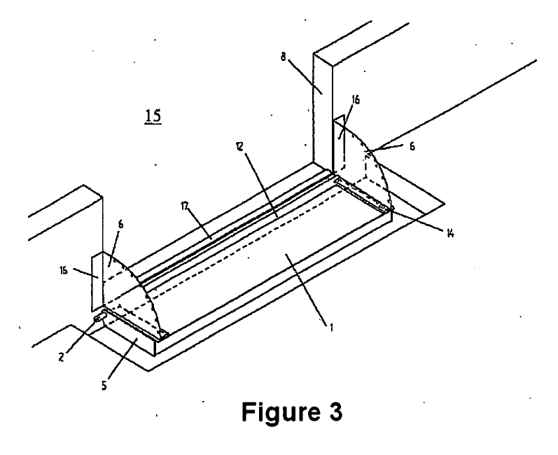

FIG. 3 shows a practical example of an arrangement according to the invention for closing off a room against a fluid flowing into the room or out from the room, especially a combustible fluid. The device has a hinged partition 1, which can be pivoted from a first position into a second position around an axis 2. The hinged partition 1 is sunk into a recess in the floor, so that one can drive through or walk through a passageway 15. The hinged partition 1 has flaps 6 on the side, which are attached to the frame 8 with fixing means 16. The frame 8 can, be, for example, the masonry of a passageway. It is also possible for the frame 8 to be, for example, a steel construction.

The strip 4 is also placed on frame 8 by means of a cover strip 17.

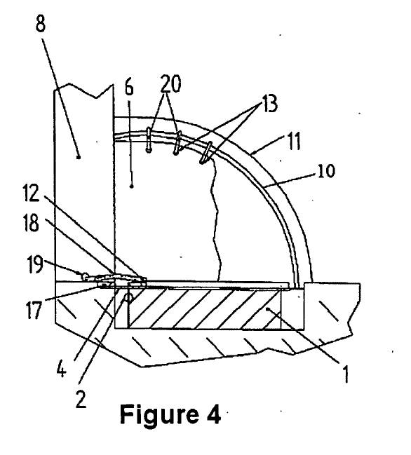

A second embodiment of the arrangement is shown in FIG. 4 in a cross-section. The arrangement has a hinged partition 1, which corresponds essentially to the hinged partition 1 according to FIG. 1. The hinged partition 1 has a seal 3 which has a strip 4. The strip 4 is attached by means of cover strip 12 to hinged partition 1 and by means of cover strip 17 to the frame 8. Over the strips and preferably over the entire width of the passageway 15, a drive-over protection 18 is arranged. The drive-over protection 18 can be swiveled around an axis 19, so that through the pivoting movement of the hinged partition 1, the drive-over protection 18 is also pivoted.

A wall 11 is arranged parallel to edge 5 of the hinged partition 1, which has a side protection of flap 6. Preferably a gap is formed between edge 5 and wall 11 that is smaller than 1 cm. Optionally, ribs can be formed on edge 5 through which the gap between the edge 5 and wall 11 is reduced.

Rings 20 extend through the openings 13 of flap 6 and these are guided on a guide means 10. The guide means 10 and the rings 20 form a tightening means 7 through which the flap 6 is tightened when the hinged partition 1 is transferred from the horizontal position into a vertical position.

In the practical examples shown, the hinged partition 1 can be pivoted around an essentially horizontally running axis 2. This is not absolutely necessary. The possibility also exists for the hinged partition 1 and the axis 2 to be arranged in such a way that pivoting around a, for example, essentially vertical axis is made possible.

The hinged partition 1 may be made as light construction in which the core of the hinged partition is equipped with an extremely light and compression-resistant material that permits application of a high load to the hinged partition. Preferably, the hinged partition is designed so that, for example, even vehicles can drive over the hinged partition. Especially, the hinged partition is arranged in a trough, which is not shown, whereby the surface of the hinged partition is flush with the top side of the trough when the hinged partition is in the first position. As a rule, the trough is arranged in front of a passageway 15. The passageway 15 can be, for example, a gate, a door or similar. Preferably, the hinged partition has dimensions such that in the second position of the hinged partition this will extend at least over the entire width of the passageway so that no fluid can flow through the passageway into a neighboring room or into the surroundings of the room.

The hinged partition can be equipped with a drive. For example this can be a drive as is also known from EP 0 754 822 A1.

Preferably, the hinged partition or the arrangement is designed in such a way that a locking device is provided with which the hinged partition is held in the first position. A triggering device cooperates with the locking device so that the hinged partition is released for pivoting it into the second position. Preferably the triggering device has a unit with which the level of a fluid is detected. The unit can be arranged next to the hinged partition. However, this is not absolutely necessary. The triggering device can also be arranged in another location, especially where the probability is the greatest of the fluid occurring before it reaches the hinged partition.

A control device is connected to the triggering device. The control device produces some old [literal] signals to the triggering device, so that the triggering device can be activated or not.

The opening-oriented device is especially suitable for locations where the danger of fire is relatively high.

FIG. 5 shows a practical example of an arrangement for closing off a room against a fluid flowing into the room or out from the room. The arrangement has a hinged partition 1 and a frame 8. The flaps arranged on the side of a seal are not shown in FIG. 5. This seal is joined to the frame and the hinged partition.

FIG. 5 shows a screening means 21. The screening means 21 is formed by two essentially parallel walls 22, 23, which are fixed in their location in the practical example shown. The walls 22, 23 form a multilayer wall. Wall 22 preferably consists at least partially of a material that is stable at high temperatures, especially above 150° C. Especially wall 22 is made at least partially from a fire-resistant material. The wall 23 preferably serves as a mechanical protection against applications of force onto wall 22.

FIG. 6 shows another practical example of an arrangement for closing off a room. The arrangement has two walls 22, 23 that are essentially parallel to one another and are arranged at a distance from one another. For example, a filler may be provided between walls 22, 23 through which the fire resistance of the screening means is increased even further. A first insulating element 24 is provided at the edge 5 of the hinged partition 1 in the longitudinal direction of edge 5. The first insulating element 24, with a projection 25 preferably forms a guide 26 in which a second insulating element 27 is arranged. The second insulating element 27 lies against wall 22. At least one spring element 28 is arranged between the second insulating element 27 and the hinged partition 1, so that the second insulating element 27 is pressed against wall 22. The insulating elements 24, 27 form an additional flame protection, so that a seal, which is not shown, is not directly exposed to the flames.

In the embodiment shown, the insulating elements 24, 27 form at the same time a kind of labyrinth seal, which can be complemented by additional insulating elements. In the practical examples shown in FIGS. 5 and 6, the walls 22, 23 have a fixed location. This is not absolutely necessary. It is also possible for at least one of the walls, preferably wall 22, to be connected solidly with the edge 5 of the hinged partition.

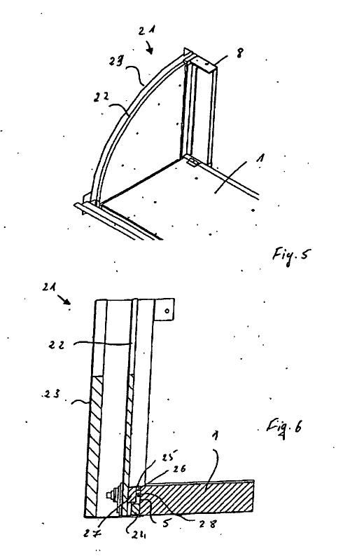

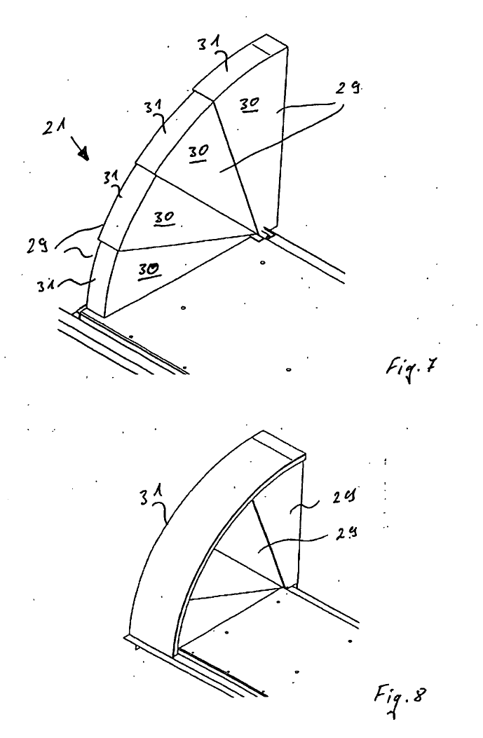

FIGS. 7 and 8 show additional practical examples of a screening means that is suitable and intended for the protection of a seal that is not shown here.

The screening means 21 according to FIG. 7 is formed by segments 29, which can be moved relative to one another and can be slid into one another. The segments 29 in the representation according to FIG. 7 have side walls 30, which are attached to cover walls 31. Two side walls 30 can, in each case be present, arranged parallel to one another, and these are joined together by the cover wall 31. It is also possible to form each of segments 29 by a side wall 30 and a cover wall 31, whereby a wall is present that is not shown and this wall is essentially parallel to the side walls 30, which borders cover walls 31. The segments 29 can be pivoted around a common axis.

FIG. 8 shows another practical example of an arrangement with a screening means. The screening means is formed by segments 29. The segments 29 have a common curved cover wall 31. A wall, not shown, is essentially parallel to segment 29 and is joined to cover wall 31. The segments 29 can be pivoted around a common axis.

FIG. 9 shows a screening means 21, which is formed by an essentially curved cover 32. The cover 32 can be pivoted around an axis 33 which is essentially horizontal. The support of cover 32 is chosen so that the cover 32 can be shifted in the axial direction, by means of which any tolerances, thermal expansions or similar can be compensated. The pivotability of the cover 32 also has the advantage that access is made possible for maintenance purposes.

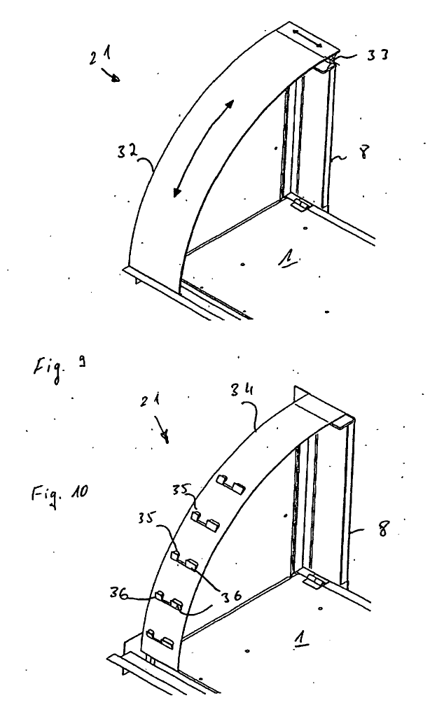

According to a still further advantageous embodiment of the arrangement, this has a screening means 21, which has at least one essentially curved flame segment 34, as shown in FIG. 10. The flame segment 34 has flame openings 35 so that flames that may occur underneath the flame segment 34 can pass through the flame openings 35. In the region of flame openings 35, flow elements 36 are provided so that a directed flow of the gases through the flame openings and away from these elements is achieved.

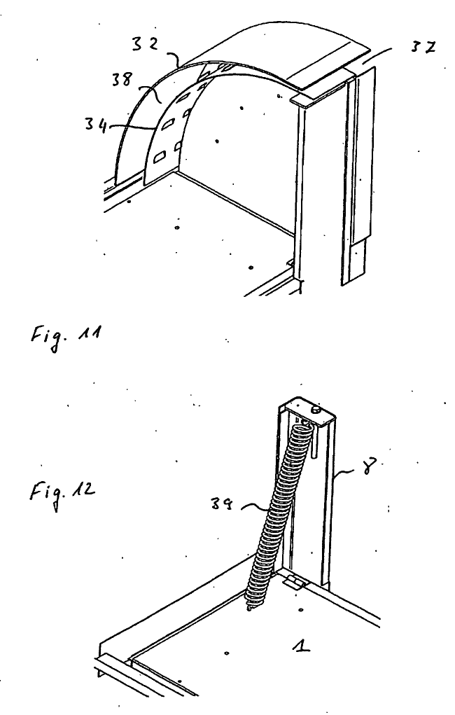

FIG. 11 shows a combination of a cover 32 in connection with a flame segment 34. The cover 32 and the flame segment 34 are arranged at a distance from one another, so that they form a channel 38. The channel 38 preferably has an exit orifice 37 on the front through which the hot gases can exit from channel 38.

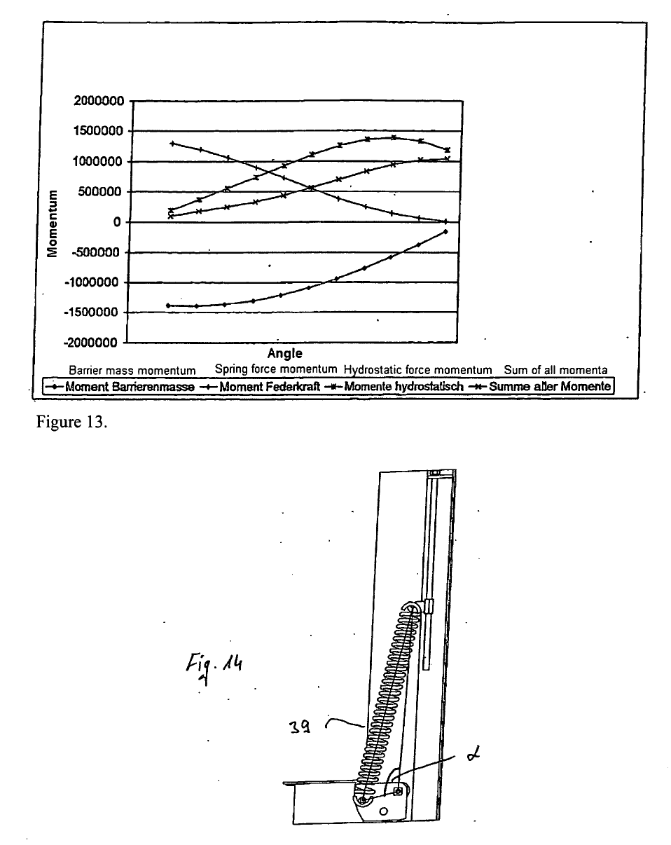

In order to move the hinged partition 1, preferably one spring 39 is arranged, which is joined to the frame 38 and the hinged partition 39. Hereby, expensive driving means for flipping up the hinged partition 1 can be omitted. Examples of changes of the momentum of the hinged partition 1 as a function of angle at the maximum possible fluid level are shown in FIG. 13. Decreasing spring action is compensated by the increase of the hydrostatic pressure. Through the rotary movement of the hinged partition, the spring path is changed, as a result of which the spring force of the spring is reduced. The hydrostatic pressure, which acts on the hinged partition, increases, however, with increasing fluid level. Through the rotary movement of the hinged partition from the horizontal position into the vertical position, the lever arm also changes and thus the torque. By suitable selection of the spring, the decreasing spring force is compensated. Several springs may be present. The springs can also have progressive spring characteristics.

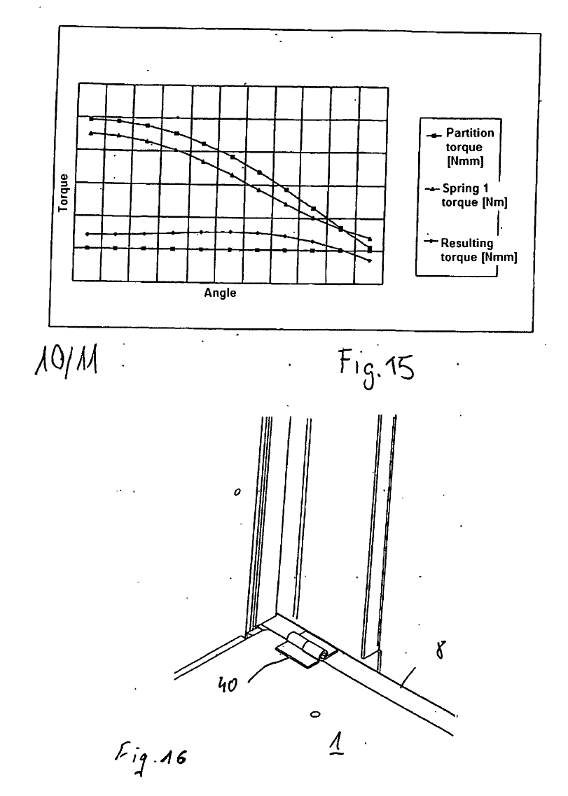

FIG. 14 shows a second design of the arrangement for attaching a spring 39. The spring 39 is arranged so that the angle between the angle α of the imaginary connecting lines between the rotary axis and the two ends of the spring and of their attachment points is greater than 90 degrees. It can be seen from the representation according to FIG. 15 that the resulting momentum is almost constant as a function of the swing angle, as a result of which when the hinged partition is flipped up manually the force that has to be applied is always constant as a function of the angle.

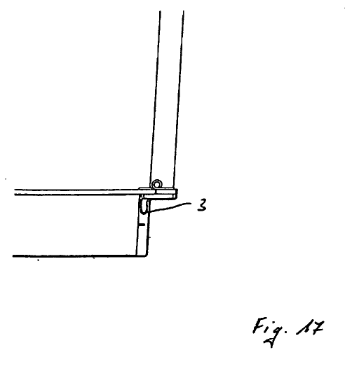

The connection between the hinged partition 1 and the frame 8 is preferably made with hinges, as can be seen from FIG. 16. An embodiment in which the hinges 40 are attached to the top side of the hinged partition 1 is especially advantageous. Such a type of attachment has the advantage that the bottom side of the hinged partition is free from joining means, which simplifies the application of the fire resistant insulation materials, since otherwise they would have to have a bore or a recess or similar in order to provide a jointed connection between the hinged partition and the frame. Especially preferred hereby is a design in which the hinges are arranged so that free longitudinal expansion of the hinged partition is possible.

An embodiment is preferred in which, for the protection of seal 3 in the region between the hinged partition and the frame, a cover is provided, which is preferably attached to the hinged partition and protrudes beyond the hinged partition far enough so that an even and continuous transition to the frame is ensured. This embodiment also opens up a drive-over protection. Driving over the hinged partition is thus possible without any differences in height, which is also advantageous at high speeds, especially for vehicles without spring action. A low-noise or noise-free travel over the hinged partition is achieved.

For even greater safety against leakage, it is proposed that the sealing with the sheet-like seal be combined with a sealing cord. For this purpose, in the lower range of a possible liquid level a sheet-like seal is used. In the upper range a sealing cord is used. In this way the space required for the side flaps is greatly reduced. In the case of pure sealing with sheet, the space requirement next to the hinge body is at least equal to the height of the closing.

If the arrangement according to the invention is used outside, especially where water, for example rain water can flow into the trough in which the hinged partition is arranged, a problem arises that an unintended floating up of the hinged partition may occur. In this case it is advantageous that the water, especially rain water, be collected in front of the device with the aid of a gutter and be led away before the liquid enters into the area of the hinged partition. Liquid can get all the way to the hinged partition only when this gutter is overloaded and thus floods over.

1. Apparatus for closing off a room against a combustible fluid flowing into or out from the room, the apparatus comprising:
a hinged partition pivotable about an axis between a first position and a second position;
a frame adjacent to the hinged partition;
a seal joined to the frame and the hinged partition and having a flap extending transversely to the axis and;
a screen disposed adjacent to the flap.

2. The apparatus according to claim 1, wherein the seal defines a planar surface.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. The apparatus according to claim 1, wherein the seal is formed at least partly from polytetrafluorethylene.

26. The apparatus according to claim 1, wherein the seal is made of a material that has an ignition temperature of at least 248° F. (150° C.).

27. The apparatus according to claim 1, wherein the seal comprises a strip extending between the hinged partition to the frame, and is removably joined to the frame.

28. The apparatus according to claim 1, wherein the flap is substantially coextensive with a width of the hinged partition.

29. The apparatus according to claim 1, wherein the flap has a substantially quarter-circle shaped cross-section.

30. The apparatus according to claim 1, and further comprising a tightener joined to the flap.

31. The apparatus according to claim 30, wherein the tightener is substantially loop shaped.

32. The apparatus according to claim 30, wherein the tightener is joined to the flap at a flap edge region.

33. The apparatus according to claim 32, and further comprising:
a guide that cooperates with the tightener and the guide is joined to the frame.

34. The apparatus according to claim 32, wherein the guide defines a wall spaced apart from an edge of the hinged partition.

35. The apparatus according to claim 34, wherein the edge defines a lip.

36. The apparatus according to claim 34, wherein the wall is made at least partly of a material that is stable at temperatures above 248° F. (150° C.).

37. The apparatus according to claim 34, wherein the wall is formed at least partially from a fire-resistant material.

38. The apparatus according to claim 34, wherein the wall has a multilayer structure.

39. The apparatus according to claim 34 and further comprising:
a barrier made of a foaming material is formed between the wall and an edge of the hinged partition when a predetermined temperature is exceeded.

41. The apparatus according to claim 34, and further comprising:
a cover disposed to cover at least a portion of the wall and an edge region of the hinged partition.

42. The apparatus according to claim 34, and further comprising:
an arcuate flame segment:

43. The apparatus according to claim 42, wherein the flame segment is disposed below the cover.

44. The apparatus according to claim 34, wherein the flap comprises:
telescoping segments.

45. The apparatus according to claim 1, and further comprising:
a drive operably joined to the hinged partition.

46. The apparatus according to claim 1, and further comprising:
a lock with which the hinged partition is held in the first position; and
a triggering device joined to the lock and with which the hinged partition is released to be pivoted into the second position.
